(19) United States
(12) Patent Application Publication
(10) Pub. No.: US 2026/0027968 A1
(43) Pub. Date: Jan. 29, 2026

(54) LAMP SYSTEM FOR VEHICLE

(71) Applicant: HYUNDAI MOBIS CO., LTD., Seoul (KR)

(72) Inventor: Myeong Je KIM, Seoul (KR)

(73) Assignee: HYUNDAI MOBIS CO., LTD., Seoul (KR)

(21) Appl. No.: 18/782,683

(22) Filed: Jul. 24, 2024

(51) Int. Cl. B60Q 5/00; B60Q 1/00; B60Q 1/08

(52) U.S. Cl. CPC B60Q 5/006; B60Q 1/0017; B60Q 1/085; B60Q 2300/112; B60Q 2300/45

(57) ABSTRACT

A lamp system for a vehicle, and an apparatus therefor are provided. The lamp system includes: a light device including light sources for outputting light; an external device to output sound waves externally; and a controller to control at least one of the light device or the external audio device, receive driving information including at least one of a position and a speed of the vehicle, and control the external audio device to output sound waves including ultrasonic waves, based on the driving information.

### CROSS-REFERENCE TO RELATED APPLICATION(S)

This application claims the benefit under 35 USC § 119 of Korean Patent Application No. 10-2023-0092816 filed on Jul. 18, 2023, in the Korean Intellectual Property Office, the entire disclosure of which is hereby incorporated by reference for all purposes.

### BACKGROUND

### 1. Field

The following disclosure relates to a lamp control system, and more particularly, to a lamp system for a vehicle.

### 2. Description of the Related Art

The traffic accident mortality rate is higher during nighttime driving than during daytime driving because drivers have a significantly narrower field of vision at nighttime than in the daytime. Typically, a headlamp of a vehicle may include a high beam and a low beam. The low beam, which is designed to direct light to below the horizon, limits the field of vision so that only short-range roads can be seen. This causes a problem of difficulty in securing a sufficient long-distance field of vision during night driving. On the other hand, the high beam helps secure visibility to see objects far away, but the use thereof is limited because it causes glare to other drivers riding in other vehicles in front of the driver.

As a system for solving this problem, the adaptive driving beam (ADB) system is a system in which the advantages of the low beam causing no glare and the high beam for securing the driver's visibility are combined. Specifically, the ADB system is a technology capable of maintaining high beams during night driving while preventing glare to another driver when another vehicle appears in front of the vehicle or in the opposite lane. To explain more specifically, it is the principle of the ADB system that headlamps are controlled to selectively dim only the parts that cause glare to a counterpart driver when the counterpart driver's vehicle is recognized through a camera sensor, and then the dimmed parts are turned on back when the counterpart driver's vehicle passes by. This operation of the ADB system makes it possible to secure a sufficient field of vision at night without causing glare to other drivers.

However, the ADB system is not capable of detecting wild animals ahead because it forms a shadow zone by recognizing a pair of light sources spaced apart from each other at a certain distance as a vehicle using a camera. The wild animals are sensitive to light. For this reason, if a headlamp illuminates a wild animal, the wild animal stops on the road to adapt its eyes to the light. As a result, wild animals are killed on the road frequently.

Related art includes Korean Patent No. 10-2008398 (entitled “DEVICE AND METHOD FOR NOTIFYING COLLISION RISK ON ROAD” issued on Jul. 5, 2019).

### SUMMARY

An embodiment of the present disclosure is directed to providing a lamp system for a vehicle capable of preventing road-kill by outputting a sound.

In one general aspect, a lamp system for a vehicle provided on the vehicle includes: a light source unit including a plurality of light sources, and configured to output light; an external audio unit configured to output sound waves to the outside of the vehicle; and a control unit configured to control at least one of the light source unit or the external audio unit, wherein the control unit controls the external audio unit to output sound waves including ultrasonic waves, based on driving information including at least one of a position and a speed of the vehicle.

If the position of the vehicle is within a predetermined caution area, the control unit may control the external audio unit to output ultrasonic waves.

If the position of the vehicle is within a predetermined caution area, and the speed of the vehicle is higher than or equal to a predetermined standard, the control unit may control the external audio unit to output ultrasonic waves.

If it is determined that there is an animal in front of the vehicle or information that there is an animal in front of the vehicle is received based on received surrounding information of the vehicle, the control unit may control the external audio unit to output ultrasonic waves.

If it is determined that there is an animal and a human in front of the vehicle or information that there is an animal and a human in front of the vehicle is received based on the received surrounding information of the vehicle, the control unit may control the external audio unit to output ultrasonic waves and audible frequency sound waves simultaneously.

While controlling the external audio unit to output ultrasonic waves and audible frequency sound waves simultaneously, the control unit may modulate the ultrasonic waves and the audible frequency sound waves in combination.

While controlling the external audio unit to output ultrasonic waves and audible frequency sound waves simultaneously, the control unit may control the ultrasonic waves and the audible frequency sound waves to be output alternately in a time-division manner.

If the position of the vehicle is within a predetermined caution area, and it is determined that there is an animal in front of the vehicle or information that there is an animal in front of the vehicle is received based on received surrounding information of the vehicle, the control unit may control the external audio unit to output ultrasonic waves.

When the position of the vehicle is within a predetermined caution area, and the speed of the vehicle is higher than or equal to a predetermined standard, if it is determined that there is an animal in front of the vehicle or information that there is an animal in front of the vehicle is received based on received surrounding information of the vehicle, the control unit may control the external audio unit to output ultrasonic waves.

The light source unit may include at least one lens, and the external audio unit may include a piezoelectric element provided on an inner surface of the lens, and configured to vibrate according to a voltage applied thereto to output ultrasonic waves.

The light source unit may include: at least one lens; and a housing accommodating the plurality of light sources and the lens, and the external audio unit may include a piezoelectric element provided on an inner surface of the housing, and configured to vibrate according to a voltage applied thereto to output ultrasonic waves.

If it is determined that there is an animal in front of the vehicle or information that there is an animal in front of the vehicle is received based on the received surrounding information of the vehicle, the control unit may control a light source positioned in a predetermined area among the plurality of light sources to be turned off.

The piezoelectric element may be provided on the inner surface of the lens provided on each of left and right sides of the vehicle, and the control unit may control the piezoelectric elements provided on the left and right sides to output respective ultrasonic waves.

In another general aspect of the disclosure, an apparatus for a vehicle to output light and sound, includes: a light device to output light from the vehicle; a sound generator to output sound waves externally from the vehicle; and a controller configured to: receive driving information including at least one of a position and a speed of the vehicle; control the light device to output light based on the driving information; control the external audio device to output sound waves, based on the driving information; and in response to at least one of the position of the vehicle being in a vicinity of a predetermined caution area, the speed of the vehicle exceeding a predetermined speed, a determination that there is an animal in front of the vehicle, or any combination thereof, control the external audio device to output ultrasonic waves.

The apparatus may further include: an external sensor configured to detect at least one of an animal, a human, or a combination thereof is in front of the vehicle, wherein, in response to the detection by the external sensor, the controller may be further configured to control the external audio device to output ultrasonic waves and audible frequency sound waves simultaneously.

In response to the detection by the external sensor, the controller may be further configured to control the sound generator to modulate the ultrasonic waves and the audible frequency sound waves.

The controller may be further configured to control the sound generator to output the ultrasonic waves and the audible frequency sound waves alternately in a time-division manner.

The light device may further include at least one lens, wherein the sound generator may include a piezoelectric element provided on an inner surface of the lens, and wherein the controller may be further configured to control the piezoelectric element to vibrate according to a voltage applied thereto to output ultrasonic waves.

In response to a determination that there is an animal in front of the vehicle or information that there is an animal in front of the vehicle is received based on the received surrounding information of the vehicle, the controller may be further configured to control the light device to turn off light aimed directly at the animal.

The lamp system for the vehicle according to various embodiments of the present invention as described above is advantageous in that road-kill can be prevented, thereby ensuring the safety of drivers and wild animals.

### BRIEF DESCRIPTION OF THE DRAWINGS

FIG. 1 is a schematic diagram illustrating a lamp system for a vehicle according to the present invention.

FIG. 2 is a schematic diagram illustrating audible frequency domains for animals.

FIG. 3 is a schematic diagram illustrating generation of vibration according to a piezoelectric element.

FIG. 4 is a graph illustrating a sound pressure characteristic of a piezoelectric element compared to a sound pressure characteristic of a coil speaker.

FIG. 5 is a diagram illustrating animal recognition using a sensor unit.

FIG. 6 is a schematic diagram illustrating a method for outputting ultrasonic sounds and audible frequency sounds simultaneously.

FIG. 7 is a diagram illustrating a comparison between a mono sound and a stereo sound.

### DETAILED DESCRIPTION

In order to describe the present invention, the present invention, the operational advantages of the present invention, and the object achieved by carrying out the present invention, preferred embodiments of the present invention will be exemplified and referred to below.

The terms used herein are merely to describe particular embodiments, and are not intended to limit the present invention. A singular expression may include a plural expression unless the context clearly indicates otherwise. It should also be understood that terms such as “include” or “have” are intended to specify the presence of features, numbers, steps, operations, components, parts, or combinations thereof stated in the specification, but do not exclude in advance the possibility of the presence or addition of one or more other features, numbers, steps, operations, components, parts or combinations thereof. In describing the present invention, if it is determined that detailed descriptions of related known configurations or functions may obscure the gist of the present invention, the detailed descriptions will be omitted.

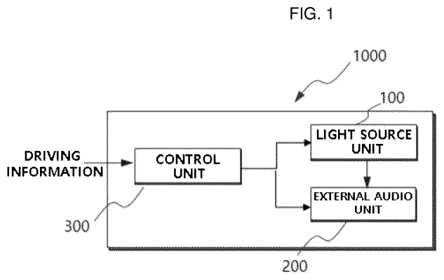

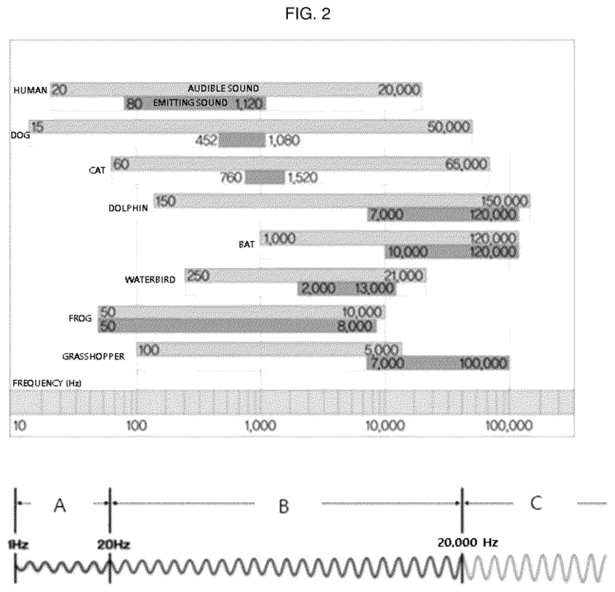

FIG. 1 is a schematic diagram illustrating a lamp system for a vehicle according to the present invention, and FIG. 2 is a schematic diagram illustrating audible frequency domains for animals.

First, as illustrated in FIG. 1, a lamp system 1000 for a vehicle according to the present invention may include a light source unit 100, an external audio unit 200, and a control unit 300.

The light source unit 100 may include a plurality of light sources, and may output light according to a control signal applied thereto.

The external audio unit 200 may output sound waves to the outside of the vehicle.

The control unit 300 may control an operation of at least one of the light source unit 100 or the external audio unit 200.

Specifically, the control unit 300 may obtain driving information including at least one of a position and a speed of the vehicle from the vehicle, and based thereon, the control unit 300 may control a light amount of the light source unit 100 or control the external audio unit 200 to output sound waves including ultrasonic waves in a specific situation.

To explain this, as illustrated in FIG. 2, an audible frequency B that humans can hear is from 20 Hz to 20,000 Hz, while a frequency that animals can hear is much higher than the frequency that humans can hear. Specifically, dogs can hear from 15 Hz to 50,000 Hz, dolphins can hear from 150 Hz to 150,000 Hz, and cats can hear from 60 Hz to 65,000 Hz.

Accordingly, the lamp system 1000 for the vehicle according to the present invention is capable of preventing road-kill of animals by outputting ultrasonic waves C that cannot be recognized by humans. (A: ultra-low frequency band).

More specifically, the control unit 300 may control the external audio unit 200 to output ultrasonic waves when the vehicle enters a predetermined caution area, based on the position as driving information obtained from the vehicle.

Here, the caution area may be an area where wild animals are expected to appear.

In addition, if the vehicle is positioned within the caution area and the speed of the vehicle is higher than or equal to a predetermined standard, the control unit 300 may control the external audio unit 200 to output ultrasonic waves.

Accordingly, only animals can recognize the sound waves, which is advantageous in that road-kill can be prevented.

In this case, the driving information may be obtained from a navigation system equipped in the vehicle, and a driver may manually set a zone where ultrasonic waves are to be output.

Specifically, the output of the ultrasonic waves in wildlife sanctuaries may be operated only on national roads, or only on highways.

It should be noted that this is merely an example, and the present invention is not limited thereto.

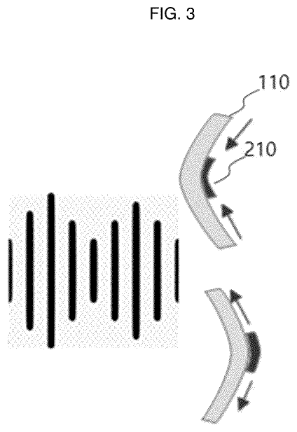

FIG. 3 is a schematic diagram illustrating generation of vibration according to a piezoelectric element.

As illustrated in FIG. 3, the light source unit 100 of the lamp system 1000 for the vehicle according to the present invention may include at least one lens 110.

In addition, the external audio unit 200 may include a piezoelectric element 210 provided on a surface of the lens 110 to output a sound according to a voltage applied thereto.

In this case, it is preferable that the piezoelectric element 210 is provided on an inner surface of the lens 110.

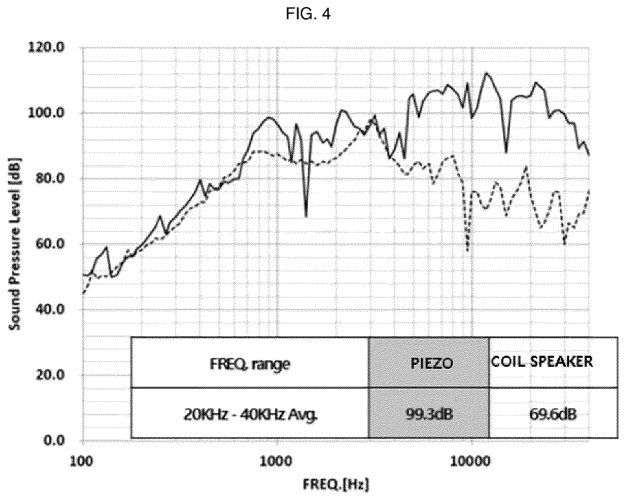

In this regard, FIG. 4 is a graph illustrating a sound pressure characteristic of a piezoelectric element compared to a sound pressure characteristic of a coil speaker.

As illustrated in FIG. 4, a speaker using a piezoelectric element 210 has a significantly superior characteristic in the ultrasonic band as compared with a speaker using a coil, and thus, an output of the piezo-speaker is preferable.

Specifically, in order to use the lens 110 of the light source unit 100 and a housing (not shown) including the same as a vibration plate when vibration is generated, the piezoelectric element 210 may be provided on the inner surface of the lens 110.

In addition, the light source unit 100 of the lamp system 1000 for the vehicle according to the present invention may include at least one lens 110 and a housing (not shown).

Here, the housing accommodates all of the plurality of light sources and lenses, and vibration is generated in a state where the piezoelectric element 210 is provided inside the housing.

More specifically, by applying a voltage converted into a signal capable of driving the piezoelectric element 210 using sound source data, the piezoelectric element 210 may contract and expand repeatedly according to the applied voltage, so that sound can be transmitted.

The position of the piezoelectric element 210 described above is merely an example, and the present invention is not limited thereto. The piezoelectric element 210 may be provided anywhere as long as it is not covered by a vehicle body structure or it has a structure capable of transmitting sound to the outside.

Meanwhile, the control unit 300 may also obtain surrounding information of the vehicle from an external sensor provided on the vehicle.

Specifically, the control unit 300 may obtain the surrounding information of the vehicle from the external sensor including at least one of a camera, an infrared camera, a lidar, a radar, and a distance detection sensor.

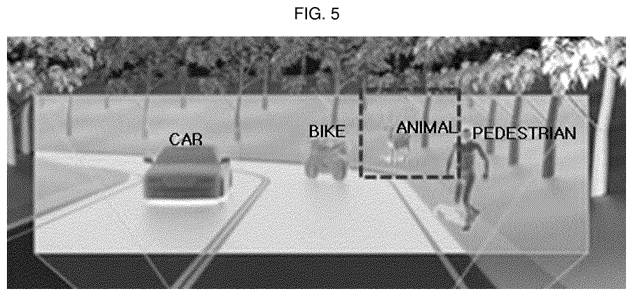

FIG. 5 is a diagram illustrating animal recognition using an external sensor.

As illustrated in FIG. 5, the control unit 300 may determine that there is an animal in front of the vehicle based on the surrounding information of the vehicle received from the external sensor. Alternatively, information that there is an animal in front of the vehicle may be received from outside.

Accordingly, the control unit 300 may control the external audio unit 200 to output ultrasonic waves when a predetermined animal is detected.

In the above-described embodiment, the method for outputting ultrasonic waves to be perceived by animals only has been described.

However, in some cases, it may be necessary to make sounds that can be perceived by both humans and animals.

Specifically, if the external sensor determines that there are both a human and an animal, the control unit 300 may control the external audio unit 200 to output sound waves in the audible frequency band and ultrasonic waves simultaneously.

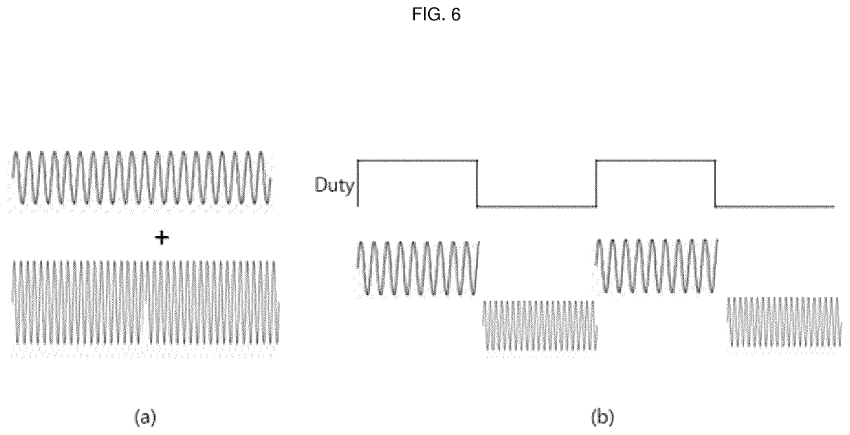

FIG. 6 is a schematic diagram illustrating a method for outputting ultrasonic sounds and audible frequency sound waves simultaneously.

Specifically, as illustrated in part (a) of FIG, 6, the control unit 300 can modulate sound waves in the audible frequency band and ultrasonic waves in combination.

Accordingly, a sound in which an audible frequency and an ultrasonic band coexist may be output.

On the other hand, as illustrated in part (b) of FIG. 6, the control unit 300 may also control the sound waves in the audible frequency band and the ultrasonic waves to be output alternately in a time-division manner.

In addition, if the driver presses a horn, the control unit 300 may output at least one of ultrasonic waves or audible frequency sound waves depending on the object.

Specifically, if it is determined that there is a human or information that there is a human is received based on the surrounding information of the vehicle received from the external sensor, the control unit 300 may output audible frequency sound waves.

Conversely, if it is determined that there is an animal or information that there is an animal is received based on the surrounding information of the vehicle received from the external sensor, the control unit 300 may output ultrasonic waves.

In addition, according to the present invention, if the position of the vehicle is within a caution area, and it is determined that there is an animal in front of the vehicle or information that there is an animal in front of the vehicle is received based on the surrounding information of the vehicle received from the external sensor, the control unit 300 may control the external audio unit 200 to output ultrasonic waves.

In addition, when the position of the vehicle is within the caution area, and the speed of the vehicle is higher than or equal to a predetermined standard, if it is determined that there is an animal in front of the vehicle or information that there is an animal in front of the vehicle is received based on the received surrounding information of the vehicle, the control unit 300 may control the external audio unit 200 to output ultrasonic waves.

In addition, when the position of the vehicle is within the caution area, if the driver presses a horn, the control unit 300 may control the external audio unit 200 to output ultrasonic waves and audible frequency sound waves simultaneously.

In addition, even though the position of the vehicle is not within the caution area, if the driver presses a horn, and it is determined that there is an animal in front of the vehicle or information that there is an animal in front of the vehicle is received based on the received surrounding information of the vehicle, the control unit 300 may control the external audio unit 200 to output ultrasonic waves and audible frequency sound waves simultaneously.

In addition, if the time for which the driver presses the horn is shorter than a predetermined standard, the control unit 300 may control the external audio unit 200 to output audible frequency sound waves only. If the driver continues to press the horn for a time longer than or equal to the predetermined standard, the control unit 300 may control the external audio unit 200 to output audible frequency sound waves and ultrasonic waves simultaneously.

In addition, if the force with which the driver presses the horn is smaller than a predetermined standard, the control unit 300 may control the external audio unit 200 to output audible frequency sound waves only. If the driver continues to press the horn with a force larger than or equal to the predetermined standard, the control unit 300 may control the external audio unit 200 to output audible frequency sound waves and ultrasonic waves simultaneously.

Meanwhile, nocturnal wild animals having dilated pupils at night may react sensitively even to a small amount of light. For this reason, if a headlamp illuminates a wild animal, the wild animal may become unmovable as it is adapting its eyes to the light.

Therefore, the control unit 300 may also control the light source unit 100 when a predetermined animal is detected by the external sensor.

Specifically, the control unit 300 may control a light source positioned in a predetermined area among the plurality of light sources to be turned off based on information sensed by the external sensor.

More specifically, by turning off a high beam of the headlamp and outputting ultrasonic waves from the external audio unit 200, it is possible to keep the animal away from the vehicle.

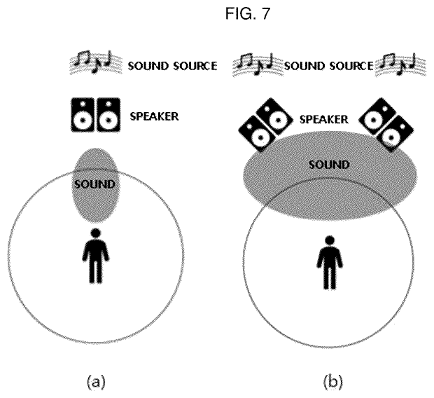

FIG. 7 is a diagram illustrating a comparison between a mono sound and a stereo sound.

In FIG. 7, (a) represents the mono sound, and (b) represents the stereo sound.

The term “mono” refers to a sound reproduction method in which all audio signals are combined into one and output through a single channel, while the term “stereo” refers to a sound reproduction method in which two or more independent sound channels are used through a symmetrical configuration of speakers.

When compared to the mono reproduction method, the stereo reproduction method is capable of outputting a more realistic and three-dimensional sound by producing sounds through two speakers.

Therefore, the piezoelectric element 210 according to the present invention may be provided on the inner surface of the lens 110 provided on each of the left and right sides of the vehicle.

In addition, the control unit 300 may control the plurality of piezoelectric elements 210 provided on the left and right sides to output respective sounds.

By outputting sounds using the two piezoelectric elements 210, a three-dimensional sound can be generated, and a vehicle width can be recognized accordingly.

Furthermore, the output of the sound may be adjusted according to a user's setting.

Specifically, the maximum output of ultrasonic waves can be adjusted depending on the surrounding environments and the driver's driving tendencies.

More specifically, if there is an animal farm nearby, the intensity of ultrasonic waves to be output may be adjusted to be weak so as not to stress animals in the farm. On the other hand, for a driver driving at a high speed, the intensity of ultrasonic waves to be output may be adjusted to be strong so that wild animals can recognize the vehicle from a distance.

Although the preferred embodiments of the present invention have been described above, the embodiments disclosed herein are not intended to limit the technical idea of the present invention but are provided merely for illustrative purposes. Therefore, the technical idea of the present invention includes not only each of the embodiments disclosed herein but also combinations of the embodiments disclosed herein, and furthermore, the scope of the technical idea of the present invention is not limited by these embodiments. In addition, those skilled in the art to which the present invention pertains may make various changes and modifications to the present invention without departing from the spirit and scope of the appended claims, and all such appropriate changes and modifications should be considered as equivalents and fall within the scope of the present invention.

1. A lamp system for a vehicle, the lamp system comprising:
a light device including a plurality of light sources, and configured to output light;
an external audio device configured to output sound waves externally; and
a controller configured to:
receive driving information including at least one of a position and a speed of the vehicle;
control at least one of the light device or the external audio device; and
control the external audio device to output sound waves including ultrasonic waves, based on the driving information.

2. The lamp system of claim 1, wherein, in response to the position of the vehicle being within a predetermined caution area, the controller is further configured to control the external audio device to output ultrasonic waves.

3. The lamp system of claim 1, wherein, in response to the position of the vehicle being within a predetermined caution area, and the speed of the vehicle is higher than or equal to a predetermined standard, the controller is further configured to control the external audio device to output ultrasonic waves.

4. The lamp system of claim 1, wherein, in response to a determination that there is an animal in front of the vehicle or information that there is an animal in front of the vehicle is received based on received surrounding information of the vehicle, the controller is further configured to control the external audio device to output ultrasonic waves.

5. The lamp system of claim 4, wherein, in response to a determination that there is an animal and a human in front of the vehicle or information that there is an animal and a human in front of the vehicle is received based on the received surrounding information of the vehicle, the controller is further configured to control the external audio device to output ultrasonic waves and audible frequency sound waves simultaneously.

6. The lamp system of claim 5, wherein while controlling the external audio device to output ultrasonic waves and audible frequency sound waves simultaneously, the controller is further configured to modulate the ultrasonic waves and the audible frequency sound waves in combination.

7. The lamp system of claim 5, wherein while controlling the external audio device to output ultrasonic waves and audible frequency sound waves simultaneously, the controller is further configured to control the ultrasonic waves and the audible frequency sound waves to be output alternately in a time-division manner.

8. The lamp system of claim 1, wherein, in response to the position of the vehicle being within a predetermined caution area, and a determination that there is an animal in front of the vehicle or information that there is an animal in front of the vehicle is received based on received surrounding information of the vehicle, the controller is further configured to control the external audio device to output ultrasonic waves.

9. The lamp system of claim 1, wherein, in response to the position of the vehicle being within a predetermined caution area, and the speed of the vehicle is higher than or equal to a predetermined standard, and a determination that there is an animal in front of the vehicle or information that there is an animal in front of the vehicle is received based on received surrounding information of the vehicle, the controller is further configured to control the external audio device to output ultrasonic waves.

10. The lamp system of claim 1,
wherein the light device further includes at least one lens, and
wherein the external audio device includes a piezoelectric element provided on an inner surface of the lens, the piezoelectric element configured to vibrate according to a voltage applied thereto to output ultrasonic waves.

11. The lamp system of claim 1,
wherein the light device further includes:
at least one lens; and
a housing to accommodate the plurality of light sources and the lens, and
wherein the external audio device includes a piezoelectric element provided on an inner surface of the housing, the piezoelectric element configured to vibrate according to a voltage applied thereto to output ultrasonic waves.

12. The lamp system of claim 4, wherein, in response to a determination that there is an animal in front of the vehicle or information that there is an animal in front of the vehicle is received based on the received surrounding information of the vehicle, the controller is further configured to control a light source positioned in a predetermined area among the plurality of light sources to be turned off.

13. The lamp system of claim 10, wherein the piezoelectric element is provided on the inner surface of the lens provided on each of left and right sides of the vehicle, and
wherein the controller is further configured to control the piezoelectric elements provided on the left and right sides to output respective ultrasonic waves.

14. An apparatus for a vehicle to output light and sound, the apparatus comprising:
a light device to output light from the vehicle;
a sound generator to output sound waves externally from the vehicle; and
a controller configured to:
receive driving information including at least one of a position and a speed of the vehicle;
control the light device to output light based on the driving information;
the external audio device to output sound waves, based on the driving information; and
in response to at least one of the position of the vehicle being in a vicinity of a predetermined caution area, the speed of the vehicle exceeding a predetermined speed, a determination that there is an animal in front of the vehicle, or any combination thereof, control the external audio device to output ultrasonic waves.

15. The apparatus of claim 14, further comprising:
an external sensor configured to detect at least one of an animal, a human, or a combination thereof is in front of the vehicle,
wherein, in response to the detection by the external sensor, the controller is further configured to control the external audio device to output ultrasonic waves and audible frequency sound waves simultaneously.

16. The apparatus of claim 15, wherein, in response to the detection by the external sensor, the controller is further configured to control the sound generator to modulate the ultrasonic waves and the audible frequency sound waves.

17. The apparatus of claim 15, wherein the controller is further configured to control the sound generator to output the ultrasonic waves and the audible frequency sound waves alternately in a time-division manner.

18. The apparatus of claim 14,
wherein the light device further includes at least one lens,
wherein the sound generator includes a piezoelectric element provided on an inner surface of the lens, and
wherein the controller is further configured to control the piezoelectric element to vibrate according to a voltage applied thereto to output ultrasonic waves.

19. The apparatus of claim 14, wherein, in response to a determination that there is an animal in front of the vehicle or information that there is an animal in front of the vehicle is received based on the received surrounding information of the vehicle, the controller is further configured to control the light device to turn off light aimed directly at the animal.
